(19) United States
(12) Patent Application Publication
(10) Pub. No.: US 2025/0309986 A1
(43) Pub. Date: Oct. 2, 2025

(54) DUAL PON AND WIRELESS SYSTEM

(71) Applicant: ARRIS Enterprises LLC, Horsham, PA (US)

(72) Inventors: David BOWLER, Stow, MA (US); John Charles CHAMBERLAIN, Hickory, NC (US); Erik J. GRONVALL, Bloomington, MN (US)

(73) Assignee: ARRIS Enterprises LLC, Horsham, PA (US)

(21) Appl. No.: 18/863,228

(22) PCT Filed: Apr. 18, 2023
(86) PCT No.: PCT/US2023/018955

§ 371 Date: Nov. 5, 2024

Related U.S. Application Data
(60) Provisional application No. 63/338,723, filed on May 5, 2022.

(51) Int. Cl. H04B 10/27; H04B 10/2575

(52) U.S. Cl. CPC H04B 10/27; H04B 10/25753

(57) ABSTRACT

A communications network that includes an optical line terminal. The optical line terminal may determine if an ONT has degraded data communications connectivity based upon an increased error rate with the optical line terminal. In response to the determining the degraded data communications providing a control signal to the optical network terminals indicating instructing it not to send further data communications to the optical line terminal until directed to do so by the optical line terminal. In response to the determining the degraded data communications providing a failover to a cellular network.

### CROSS REFERENCE TO RELATED APPLICATIONS

This application is a 371 International Patent application claiming priority to PCT application No. PCT/US23/18955 filed Apr. 18, 2023, which claims the benefit of U.S. Provisional Patent Application Ser. No. 63/338,723 filed May 5, 2022.

### BACKGROUND

The subject matter of this application relates to a passive optical network.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 100, a set of optical fibres and passive interconnecting devices are used for most or all of the communications through the extent of the access network. A set of one or more optical network terminals (ONTs) 110 are devices that are typically positioned at a subscriber's residence location (e.g., or business location). The term “ONT” includes what is also referred to as an optical network unit (ONU). There may be any number of ONTs associated with a single optical splitter 120. By way of example, 32 or 64 ONTs are often associated with the single network optical splitter 120. The optical splitter 120 is interconnected with the respective ONTs 110 by a respective optical fiber 130, or otherwise a respective fiber within an optical fiber cable. Selected ONTs may be removed and/or added to the access network associated with the optical splitter 120, as desired. There may be multiple optical splitters 120 that are arranged in a cascaded arrangement.

The optical fibers 130 interconnecting the optical splitter 120 and the ONTs 110 act as access (or “drop”) fibers. The optical splitter 120 is typically located in a street cabinet or other structure where one or more optical splitters 120 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 140 is located at the central office where it interfaces directly or indirectly with a core network 150. An interface 160 between the OLT 140 and the core network 150 may be one or more optical fibers, or any other type of communication medium. The OLT 140 forms optical signals for transmission downstream to the ONTs 110 through a feeder optical fiber 170, and receives optical signals from the ONTs 110 through the feeder optical fiber 170. The optical splitter 120 is typically a passive device that distributes the signal received from the OLT 140 to the ONTs 110. Similarly, the optical splitter 120 receives optical signals from the ONTs 110 and provides the optical signals though the feeder optical fiber 170 to the OLT 140. In this manner, the PON includes an OLT with a plurality of ONTs, which reduces the amount of fiber necessary as compared with a point-to-point architecture.

As it may be observed, an optical signal is provided to the feeder fiber 170 that includes all of the data for the ONTs 110. Accordingly, all the data being provided to each of the ONTs is provided to all the ONTs through the optical splitter 120. Each of the ONTs selects the portions of the received optical signals that are intended for that particular ONT and passes the data along to the subscriber, while discarding the remaining data. Typically, the data to the ONTs are broadcast to the feeder fiber 170 and provided to each of the ONTs.

Upstream transmissions from the ONTs 110 through the respective optical fibers 130 are typically transmitted in bursts according to a schedule provided to each ONT by the OLT. In this way, each of the ONTs 110 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

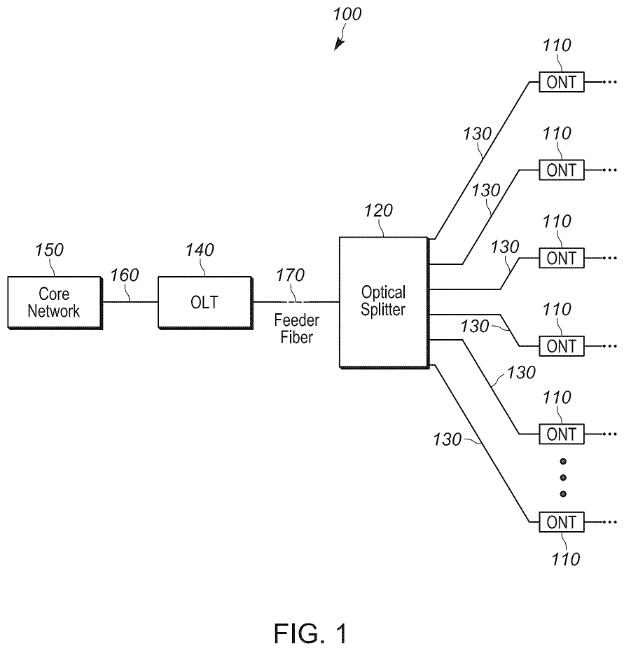

FIG. 2 illustrates a geographic region with cellular towers and their respective service areas.

FIG. 3 illustrates a cellular network termination unit.

FIG. 4 illustrates a cellular network and a PON network.

FIG. 5 illustrates a cellular network and a PON network with a wireless gate and remote OLT.

### DETAILED DESCRIPTION

When a service provider considers providing data connectivity using PON to a neighborhood, there is a substantial upfront expense and time involved in the installation of the fiber optical cables and other components of the network to each of the residences (or otherwise businesses). By way of example, the fiber needs to be routed from a central office to the neighborhood, together with a set of splitters and/or other components, to provide fiber to each of the residences. The fiber is often routed by being suspended from adjacent telephone poles or otherwise buried in a conduit within the ground. In either case, there is a substantial financial burden and time involved with obtaining permission to route the fiber optical cables together with the installation itself, often with a very limited number of initial subscribers using the data connectivity services that such a PON network provides. In addition, for each subscriber, the fiber optical cable is extended to and typically within each of the subscribers' residence.

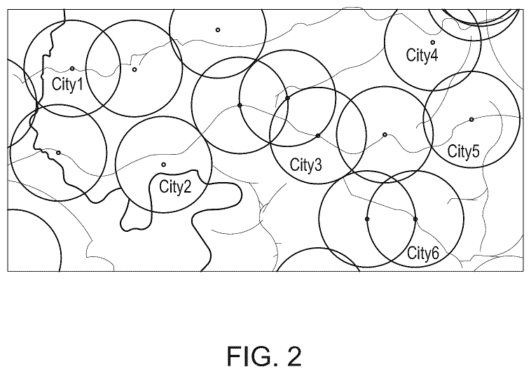

It was determined that rather than initially building out the complete PON network to provide data services to potential subscribers, it is desirable to reduce the upfront expenses and time for installation by making use of already existing cellular towers which provide wireless two-way data connectivity. Referring to FIG. 2, a set of exemplary cellular towers that provide data connectivity (e.g., EV-DO, SVDO, UMTS, HSDPA, HSUPA, HSPA+, LTE, LTE Advanced, LTE Advanced Pro, NR, 3G, 4G, 5G, etc.) to devices are illustrated. Each of the cellular towers has a coverage area, which may be any suitable shape such as circular. Typically, the circular coverage area has a coverage area of generally a 1.5-km radius in suburban areas, 750 m in typical urban environments, and 5 km in rural areas.

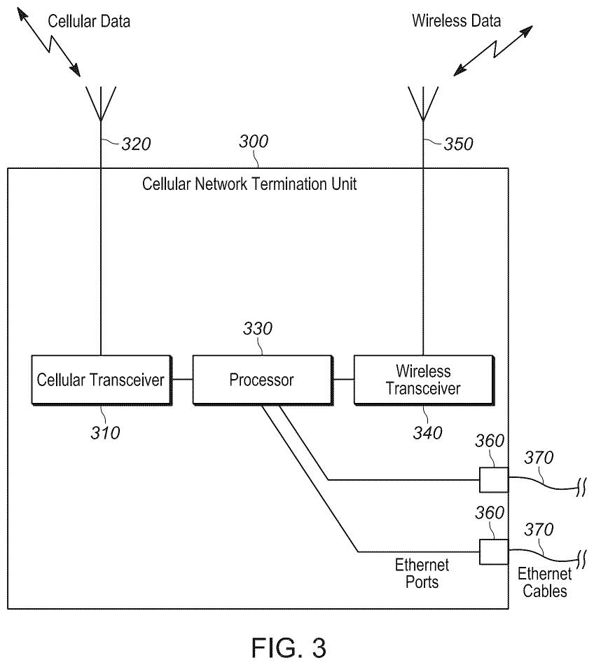

Further referring to FIG. 3, the service provider may initially provide data connectivity to each subscriber within a geographic area serviced by one or more cellular towers by providing each subscriber with a cellular network termination unit 300 that includes a cellular transceiver 310 (i.e., capable of receiving data wirelessly from the cellular tower and capable of transmitting data wirelessly to the cellular tower). The cellular network termination unit 300 may include an antenna 320 for receiving and sending cellular data to the cellular tower. The cellular network termination unit 300 may include a processor 330 for processing the data received from and transmitted to the cellular tower. The cellular network termination unit 300 may further include a wireless transceiver 340 and wireless antenna 350, such as one supporting one or more of the 802.11 family of standards, to transmit data to the subscriber's devices within the residence and to receive data from the subscriber's devices within the residence. The cellular network termination unit 300 may further include one or more Ethernet ports 360 or other manner of physical connection to a network, such as using one or more Ethernet cables 370, within the residence for sending and receiving data from the subscriber's devices. In general, the cellular network termination unit 300 uses the carrier network to route data between connected LAN devices within the residence and the cellular tower. In this manner, the cellular network termination unit 300 may facilitate the transmission of data to the cellular tower and the receiving of data from the cellular tower, and further from the Internet or other network devices.

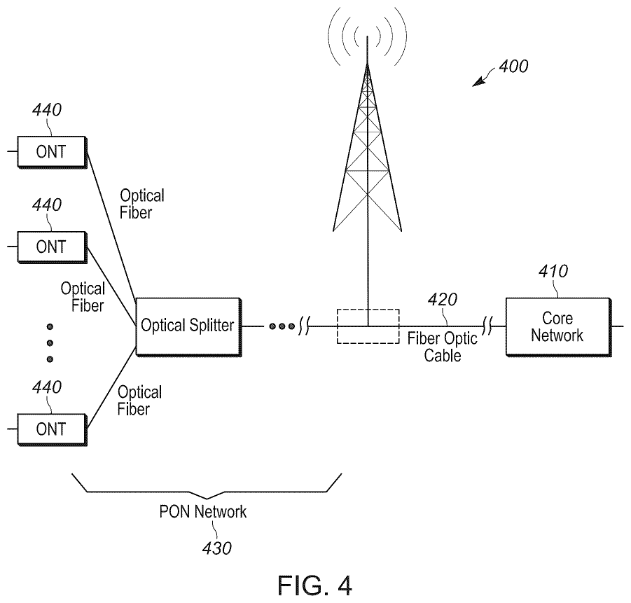

Referring to FIG. 4, in many cases the cellular tower 400 is interconnected to the central office, head end, or otherwise (i.e., core network) 410 by one or more fiber optical cables 420 to facilitate the sending and receiving of data using the cellular tower 400. With the fiber optical cable 420 already installed between the core network 410 at the cellular tower 400, this provides a suitable location from which to extend the fiber optical network for a particular neighborhood and the subscribers therein using a PON based network 430. Each of the subscribers would include an ONT 440 to provide an interface to the PON network 430, and thereby be able to send and receive data over an optical fiber to the core network 410 which is interconnected to the Internet or otherwise other network devices. Also, it is noted that the backhaul optical fiber 420 may be shared between the cellular tower 400 and a remote OLT (described below) for data communications.

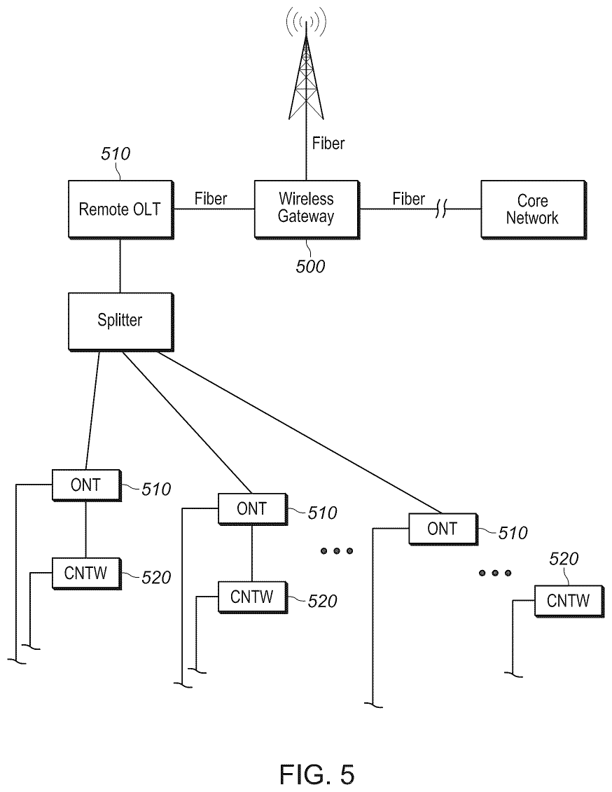

Referring to FIG. 5, one architecture that enables the use of a PON network for data communications, the optical fiber provided to the cellular tower from the core network, and the cellular tower for data communications, is to include a wireless gateway 500 proximate the cellular tower, such as at the base of the cellular tower or otherwise within ¼ mile of the cellular tower, and more preferably within ⅛^{th} of a mile of the cellular tower, and more preferably within 1/16^{th} of a mile of the cellular tower. The core network is preferably more than 1 mile from the cellular tower, more preferably more than 2 miles from the cellular tower, and more preferably more than 5 miles from the cellular tower. The wireless gateway is a form of an Ethernet switch that routes the optical signals on the fiber connections between the cellular tower, the core network, and a remote OLT. In this manner, data signals from the core network can be routed to the cellular tower and data signals from the cellular tower can be routed to the core network. In this manner, data signals from the core network can be routed to the remote OLT 510 and data signals from the remote OLT 510 can be routed to the core network. Preferably, data from the cellular tower is not routed to the remote OLT. Preferably data from the remote OLT is not routed to the cellular tower. The remote OLT performs the functionality of an OLT, but it is located at a location proximate the cellular tower, such as at the base of the cellular tower or otherwise within ¼ mile of the cellular tower, and more preferably within ⅛^{th} of a mile of the cellular tower, and more preferably within 1/16^{th} of a mile of the cellular tower. The remote OLT receives data, preferably from an optical fiber from the wireless gateway, and provides an output on a fiber optical cable on the PON network. The PON network may include suitable components, such as a splitter. Each of the subscribers to the PON network may include a respective ONT 520 so that data may be received from the OLT 510 and data may be provided to the OLT 510. Alternatively, the fiber from the core network may include signals provided at different wavelengths, such that the wireless gateway provides signals at a first wavelength to the cellular tower and provides signals at a second wavelength to the remote OLT. In some cases, the signals at both the wavelengths are provided to both the cellular tower and the remote OLT, but each of them only acts and processes the signals for their respective wavelengths.

As it may be observed, some subscribers in the neighborhood may only have a respective ONT interconnected with the remote OLT for data communications. As it may be observed some subscribers in the neighborhood may only have a cellular network termination unit interconnected to the cellular tower for data communications. As it may be observed some subscribers in the neighborhood may have both an ONT interconnected with the remote OLT for data communications and a cellular network termination unit interconnected to the cellular tower for data communications. For those subscribers that maintain both the ONT and the cellular network termination unit, they are preferably interconnected with one another, such as by a network cable or a wireless interconnection (e.g., Bluetooth). Otherwise, the ONT and the cellular network termination unit may be integrated into the same housing, if desired.

To increase the overall downstream bandwidth to a particular subscriber, the wireless gateway (which may be integrated with the OLT, if desired) may provide link aggregation by combining (i.e., aggregating) the wireless cellular data communication and the fiber optical PON data communication in parallel to a subscriber's ONT and cellular network termination unit. This enables an increase in throughput beyond what a single connection can sustain. The ONT and/or cellular network termination unit may communicate with one another to reassemble the data communications to provide a suitable data stream to the subscriber's devices at their residence. In another option, the system may measure, or otherwise have data indicating, the latency through each of the paths and directs the traffic that requires lower latency through the lower latency path.

To increase the overall upstream bandwidth from a particular subscriber, the ONT and cellular network termination unit may provide link aggregation by combining (i.e., aggregating) the wireless cellular data communication and the fiber optical PON data communication in parallel to the wireless gateway. This enables an increase in throughput beyond what a single connection can sustain. The wireless gateway may reassemble the data communications to provide a suitable data stream to the core network.

To provide redundancy in the downstream direction to a particular subscriber, the wireless gateway may provide failover to a subscriber by sensing that the PON network is not resulting in suitable data communications being received by the ONT of the subscriber, in which case, the wireless gateway redirects the data communications to the cellular tower so that the data communications may be received by the respective cellular network termination unit of the subscriber. In a similar manner, to provide redundancy in the downstream direction to a particular subscriber, the wireless gateway may provide failover to a subscriber by sensing that the cellular tower is not resulting in suitable data communications being received by the cellular network termination unit of the subscriber, in which case, the wireless gateway redirects the data communications to the remote OLT so that the data communications may be received by the respective ONT of the subscriber.

To provide redundancy in the upstream direction from a particular subscriber, the ONT and/or cellular network termination unit may provide failover for a subscriber by sensing that the PON network is not resulting in suitable data communications being received by the wireless gateway and/or remote OLT of the network, in which case, the ONT and/or cellular network termination unit redirects the data communications to the cellular tower so that the data communications may be received by the wireless gateway. In a similar manner, to provide redundancy in the upstream direction from a particular subscriber, the ONT and/or cellular network termination unit may provide failover for a subscriber by sensing that the wireless network is not resulting in suitable data communications being received by the wireless gateway and/or cellular tower of the network, in which case, the ONT and/or cellular network termination unit redirects the data communications to the PON network so that the data communications may be received by the wireless gateway and/or remote OLT.

In some situations, the outage for effective communications between the remote OLT and the ONT can occur as the result of different sources. In some situations, the ONT is power cycled as a result of a power interruption. As a result of the ONT being power cycled, the ONT will go through its activation process in a manner that it connects and/or reconnects with the PON network. This may include, for example, parameter learning, serial number acquisition, and ranging. During this power cycle, the failover process to the wireless communication may be performed, if desired, while the ONT connects and/or reconnects to the PON network.

In some situations, the ONT experiences a degradation of its data connectivity with an increasing error rate occurring. This may be the result of, for example, a tree limb leaning on the optical fiber. As a result, the OLT may determine the increasing error rate of the ONT which is likely the result of a physical change in the network itself, and determine that the ONT is not suitable for continued data communications. In such a case the OLT sends a command signal to the ONT to instruct the ONT not to send further communications to the network until directed to do so by the OLT. By way of example, the command signal may be a disable serial number message with a disable option. In this state, the ONT switches off the laser (or otherwise) and rejects all TC settings (ONU-ID, equalization delay, burst profiles, etc.). The ONT keeps the downstream synchronization machine running and may analyze frames in the downstream direction, but is forbidden to pass any downstream data or send any upstream data. When the problem is resolved, the OLT can re-enable the ONT with a suitable command to bring it back to normal operation, such as by sending the disable serial number command with an enable option.

Preferably, as a result of sending the command signal to the ONT instructing the ONT not to send further communications to the network, the system automatically includes a fail-over to the cellular network by the wireless gateway and/or OLT. In this manner, data communication to the subscriber is not substantially interrupted, albeit at likely a lower data rate.

After a technician determines the source of the degraded data communications with the ONT, and the technician attempts or otherwise remediates the portion of the network causing the signal derogation, the OLT may be signalled to provide a command signal to the ONT for it to re-join the PON network. At this point, the failover to the cellular network may be suspended, if desired.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A communications network comprising:
(a) an optical line terminal including a first optical fiber connection suitable to receive digital data from a core network and provide digital data to said core network;
(b) said optical line terminal including a second optical fiber connection suitable to receive digital data from a plurality of optical network terminals and to provide digital data to said plurality of optical network terminals;
(c) said optical line terminal determining a first one of said optical network terminals corresponding to a subscriber is having degraded data communication connectivity based upon an increased error rate with said optical line terminal;
(d) in response to said determining said first one of said optical network terminals is having said degraded data communications providing a control signal to said first one of said optical network terminals indicating said first one of said optical network terminals is instructed not to send further data communications to said optical line terminal until directed to do so by said optical line terminal;
(e) in response to said determining said first one of said optical network terminals is having said degraded data communications redirecting data communications that would have otherwise been provided by said optical line terminal to said first one of said optical network terminals to a cellular tower to provide said redirected data communications to a cellular network termination unit of said subscriber.

2. The communication network of claim 1 where said cellular network termination unit further comprises a cellular transceiver to send and receive data communications from said cellular tower.

3. The communication network of claim 3 where said cellular network termination unit further comprises a wireless transceiver to send and receive data communications from devices of said subscriber using wireless communications.

4. The communication network of claim 4 where said cellular network termination unit further comprises an Ethernet port to send and receive data communications from devices of said subscriber using said Ethernet port.

5. The communication network of claim 1 further comprising a wireless gateway interconnecting said optical line terminal and said cellular tower with a core network, where said core network is interconnected with the Internet.

6. The communication network of claim 5 wherein said interconnection between said optical line terminal and said wireless gateway is with an optical fiber.

7. The communication network of claim 6 wherein said interconnection between said cellular tower and said wireless gateway is with an optical fiber.

8. The communication network of claim 7 wherein said interconnection between said core network and said wireless gateway is with an optical fiber.

9. The communication network of claim 8 wherein said wireless gateway is positioned within ¼ mile of said cellular tower.

10. The communication network of claim 9 wherein said core network is positioned greater than 1 mile from said cellular tower.

11. The communication network of claim 10 wherein said optical line terminal is positioned within ¼ mile of said cellular tower.
